(19) United States
(12) Patent Application Publication
(10) Pub. No.: US 2016/0344912 A1
(43) Pub. Date: Nov. 24, 2016

(54) CAMERA MODULE

(71) Applicant: SAMSUNG ELECTRO-MECHANICS CO., LTD., Suwon-si (KR)

(72) Inventors: Jae Ho BAIK, Suwon-si (KR); Shin Young CHEONG, Suwon-si (KR); Byung Hoon LEE, Suwon-si (KR); Sang Ho SEO, Suwon-si (KR); Yong Wan CHO, Suwon-si (KR); Hyun Taek AHN, Suwon-si (KR)

(73) Assignee: SAMSUNG ELECTRO-MECHANICS CO., LTD., Suwon-si (KR)

(21) Appl. No.: 15/009,484

(22) Filed: Jan. 28, 2016

(30) Foreign Application Priority Data
May 20, 2015 (KR) 10-2015-0070610

(51) Int. Cl. H04N 5/225

(52) U.S. Cl. CPC H04N 5/2257; H04N 5/2253; H04N 5/2254

(57) ABSTRACT

A camera module includes a fixed unit having an accommodating space; a moveable unit disposed in the accommodating space; an actuator configured to drive the movable unit in an optical axis direction; a substrate, disposed on a first side surface of the fixed unit, including a coil member of the actuator disposed on a first surface of the substrate; and connection pads, disposed on a second surface of the substrate, electrically connected to the coil member.

### CROSS-REFERENCE TO RELATED APPLICATION

This application claims the benefit under 35 USC 119(a) of Korean Patent Application No. 10-2015-0070610 filed on May 20, 2015, with the Korean Intellectual Property Office, the entire disclosure of which is incorporated herein by reference for all purposes.

### BACKGROUND

1. Field

The present disclosure relates to a camera module having an auto-focusing function. Camera modules are commonly mounted in portable electronic devices. For example, camera modules may be mounted in mobile phones.

2. Description of Related Art

Such camera modules have an auto-focusing function. For example, such camera modules include an actuator adjusting a position of a lens module depending on a distance from a subject. In this regard, it is necessary to miniaturize camera modules in order to mount such camera modules in portable electronic devices. In mobile phones, several components are integrated in a narrow space, resulting in difficult installation of a camera module in mobile phones. Therefore, there is a need to develop camera modules able to be easily mounted in compact electronic devices such as mobile phones.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a fixed unit having an accommodating space; a moveable unit disposed in the accommodating space; an actuator configured to drive the movable unit in an optical axis direction; a substrate, disposed on a first side surface of the fixed unit, including a coil member of the actuator disposed on a first surface of the substrate; and connection pads, disposed on a second surface of the substrate, electrically connected to the coil member.

In another general aspect, a camera module includes a fixed unit having a space; a moveable unit disposed in the space; an actuator configured to drive movable unit in an optical axis direction; and a substrate disposed on the fixed unit. The substrate includes a coil member disposed on a body part; a cover part folded over at least a portion of the body part; and connection pads connected to the coil member.

In another general aspect, camera module includes a fixed unit comprising a space; a moveable unit disposed in the space; an actuator configured to drive movable unit in an optical axis direction; and a substrate disposed on the fixed unit. The substrate includes a coil member disposed on a body part; a cover part folded over at least a portion of the body part; and connection pads extending from the cover part, wherein the connection pads are electrically connected to the coil member.

In a camera module according to an aspect of the present disclosure, a substrate may be folded so that disposition of the substrate for an actuator is simplified.

Other features and aspects will be apparent from the following detailed description, the drawings, and the claims.

### BRIEF DESCRIPTION OF DRAWINGS

FIG. 1 is an exploded perspective view of a camera module according to one or more embodiments;

FIG. 2 is an enlarged view of part A of a fixed unit illustrated in FIG. 1;

FIG. 3 is a front perspective view of a substrate illustrated in FIG. 1;

FIG. 4 is a rear perspective view of the substrate illustrated in FIG. 3;

FIG. 5 is a cross-sectional view of the substrate illustrated in FIG. 3;

FIG. 6 is a front perspective view illustrating an embodiment of the substrate illustrated in FIG. 3;

FIG. 7 is a rear perspective view of the substrate illustrated in FIG. 6;

FIG. 8 is a partially assembled perspective view of the camera module illustrated in FIG. 1;

FIG. 9 is an assembled perspective view of the camera module illustrated in FIG. 8;

FIG. 10 is a partially exploded perspective view of a camera module according to one or more embodiments;

FIG. 11 is a plan view of a movable unit illustrated in FIG. 10;

FIG. 12 is a perspective view of a substrate illustrated in FIG. 10;

FIG. 13 is a perspective view of a substrate according to one or more embodiments;

FIG. 14 is a perspective view of a substrate according to one or more embodiments;

FIG. 15 is a perspective view of a substrate according to one or more embodiments; and

FIG. 16 is a perspective view of a substrate according to one or more embodiments.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second component disposed above a first component based on the orientation of the device illustrated in the drawings also encompasses the device when the device is flipped upside down in use or operation.

The terminology used herein is for describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

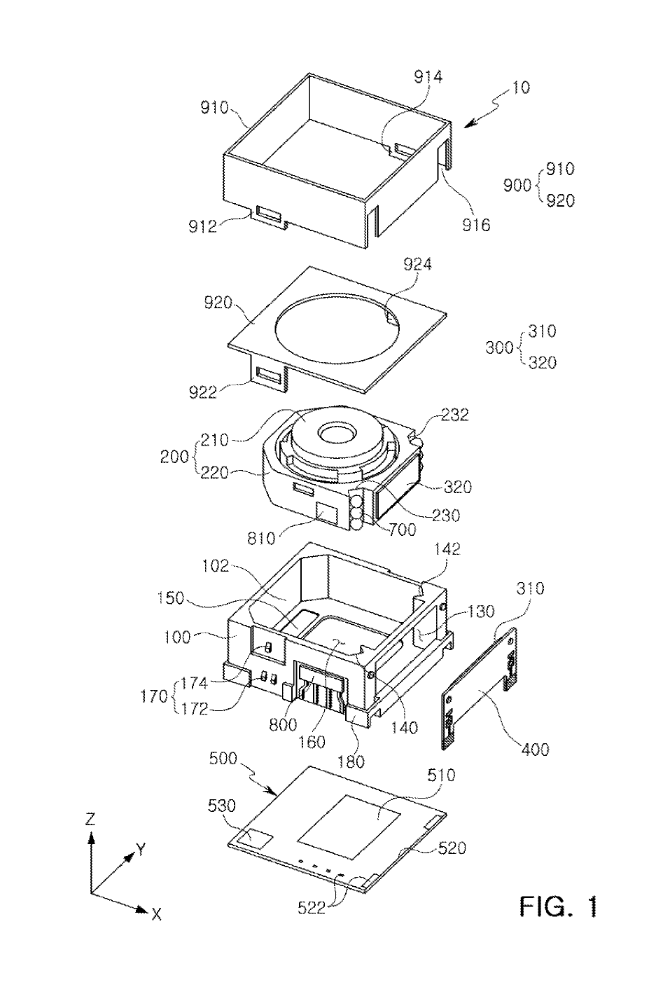

Referring to FIG. 1, a camera module 10 includes a fixed unit 100 and a movable unit 200. The fixed unit 100 accommodates the movable unit 200 therein. For example, a space 102 in which the movable unit 200 is disposed is formed in the fixed unit 100. Another member such as an actuator is mounted in the fixed unit 100. For example, a coupling opening 130 connected to the space 102 is formed in one side surface of the fixed unit 100. The fixed unit 100 is configured so that the movable unit 200 is movable. For example, a first accommodating groove 140 and a second accommodating groove 142 for guiding movement of the movable unit 200 along an optical axis direction (Z axis direction in FIG. 1) is formed in the fixed unit 100. Rolling members 700 having a spherical shape is disposed in the first and second accommodating grooves 140 and 142.

The fixed unit 100 allows light refracted through a lens of the movable unit 200 to be incident on an image sensor. For example, an incident light opening 160 having a substantially rectangular or square shape is formed in a bottom surface of the fixed unit 100. The fixed unit 100 prevents the permeation of foreign materials through a collecting groove 150 is formed in the bottom surface of the fixed unit 100. The collecting groove 150 collects the foreign materials introduced through a gap between the fixed unit 100 and the movable unit 200. The foreign material collecting groove 150 disposed along a outer perimeter of the incident opening 160.

The fixed unit 100 prevents pollution by a lubricant injected through the accommodating grooves 140 and 142. For example, lubricant accommodating grooves 152, in which a lubricant flows along the accommodating grooves 140 and 142, are formed in the bottom surface of the fixed unit 100. The lubricant accommodating groove 152 is formed in portions facing the accommodating grooves 140 and 142.

The movable unit 200 focuses light reflected from a subject onto the image sensor. For example, the movable unit 200 includes a plurality of lenses to enlarge or reduce the image of the subject. The plurality of lenses have positive refractive power or negative refractive power, or both. The movable unit 200 accommodates a number of the rolling members 700 therein. For example, a third accommodating groove 230 and a fourth accommodating groove 232 are formed in one side surface of the movable unit 200. The third and fourth accommodating grooves 230 and 232 extend in the optical axis direction. The third and fourth accommodating grooves 230 and 232 face the first and second accommodating grooves 140 and 142 of the fixed unit 100, respectively. For example, the third and fourth accommodating grooves 230 and 232 of the movable unit 200 face the first and second accommodating grooves 140 and 142 of the fixed unit 100, respectively, with the rolling members 700 interposed therebetween. A lubricant allowing the rolling members 700 to roll smoothly may be applied to the respective accommodating grooves 140, 142, 230, and 232.

The movable unit 200 includes a lens barrel 210 and a barrel holder 220. The lens barrel 210 accommodates the plurality of lenses, and the barrel holder 220 accommodates a portion of an actuator 300 therein. The lens barrel 210 may be mounted in the barrel holder 220. In the movable unit 200 configured as described above, either of the lens barrel 210 and the barrel holder 220 may be selectively replaced, such that repairs, depending on a defect of a product, may be facilitated.

The camera module 10 includes the actuator 300 for actuating, or driving the movable unit 200. For example, the actuator 300 moves the movable unit 200 in the optical axis direction. Therefore, the camera module 10 adjusts a focal length through the actuator 300.

The actuator 300 includes a coil member 310 and a magnet member 320. The coil member 310 is disposed on the fixed unit 100. For example, the coil member 310 is disposed on a substrate 400 mounted to the fixed unit 100. The magnet member 320 is disposed on the movable unit 200. For example, the magnet member 320 is attached to a side surface of the movable unit 200. The side surface of the movable unit 200 is configured so that the magnet member 320 is easily attached thereto. For example, the side surface of the movable unit 200 may be manufactured to have a predetermined degree of roughness in order to increase a surface area thereof to which an adhesive may be applied. Alternatively, fine grooves into which an adhesive may permeate may be formed in the side surface of the movable unit 200.

The magnet member 320 has a first polarity and a second polarity. For example, one portion of the magnet member 320 has the first polarity, and the other portion of the magnet member 320 has the second polarity. The first polarity and the second polarity of the magnet member 320 are disposed in one axis. For example, the first polarity and the second polarity of the magnet member 320 are disposed in the optical axis direction or a movement direction of the movable unit.

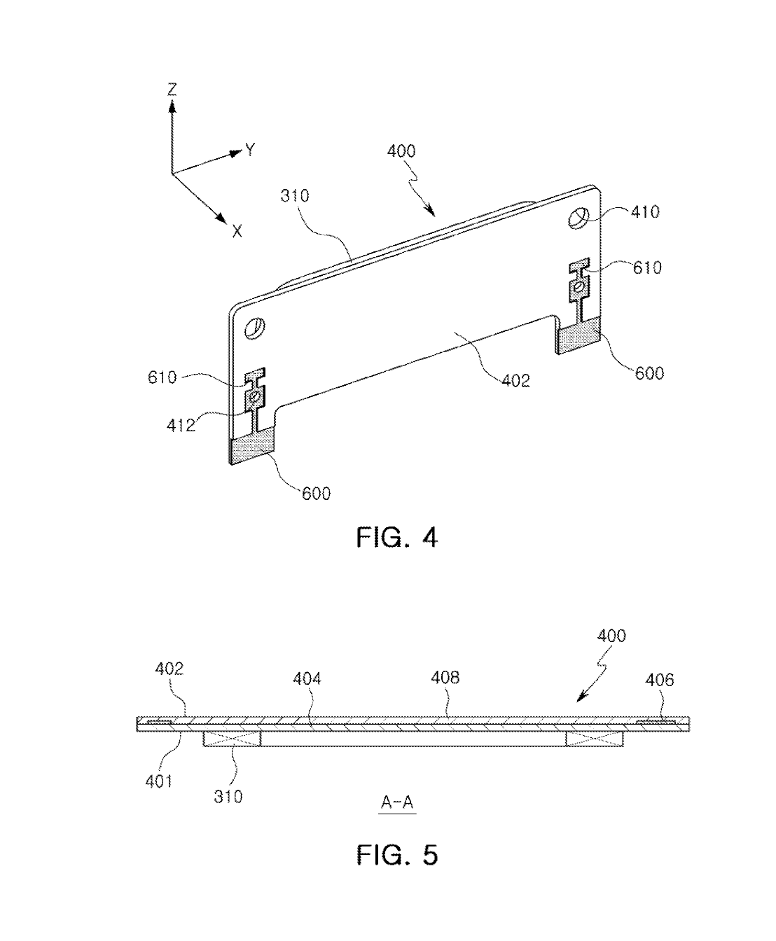

The camera module 10 includes a component for controlling the actuator 300. For example, the camera module 10 includes the substrate 400. The substrate 400 is disposed in the coupling opening 130 of the fixed unit 100. The substrate 400 is connected to an image sensor unit 500. For example, connection pads 600 (see FIG. 4) are formed on the substrate 400 for electrical connection to the image sensor. The substrate 400 is connected to the coil member 310 of the actuator 300. For example, a circuit printed on the substrate 400 is connected to the coil member 310.

The camera module 10 includes a means of sensing a movement position of the movable unit 200. For example, the camera module 10 includes a sensor member 800 for sensing the movement position of the movable unit 200. The sensor member 800 is disposed on a side surface of the fixed unit 100. For example, the sensor member 800 is disposed on a side surface of the fixed unit 100 adjacent to the coupling opening 130. The sensor member 800 is spaced apart from the coil member 310 and the magnet member 320 by a significant distance. Thus, the sensor member 800 is not significantly affected by a magnetic field of the coil member 310 and the magnet member 320. Therefore, a position of the movable unit 200 is accurately sensed by the sensor member 800. A magnetic body 810 sensed by the sensor member 800 is disposed on the movable unit 200. For example, one or more magnetic bodies 810 may be disposed on a side surface of the movable unit 200 facing the sensor member 800.

The magnetic body 810 may be a permanent magnet. For example, the magnetic body 810 may be a permanent magnet having an N pole and an S pole. The N pole and the S pole of the magnetic body 810 are aligned along one axis. For example, the N pole and the S pole of the magnetic body 810 may be aligned according to an axis along the movement direction of the movable unit.

The rolling members 700 are disposed between the fixed unit 100 and the movable unit 200. For example, the rolling members 700 are disposed between the accommodating grooves 140 and 142 of the fixed unit 100 and the accommodating grooves 230 and 232 of the movable unit 200. The rolling members 700 enable smooth movement of the movable unit 200.

The camera module 10 furthers include a shield can 900. The shield can 900 protects the camera module 10 from harmful electromagnetic waves. For example, the shield can 900 may be formed of a metal that easily blocks harmful electromagnetic waves. The shield can 900 is divided into a plurality of members. For example, the shield can 900 includes a side surface cover 910 and an upper surface cover 920. The side surface cover 910 covers side surfaces of the camera module 10, and the upper surface cover 920 covers an upper surface (surface facing the subject) of the camera module 10.

The shield can 900 is firmly coupled to the fixed unit 100. For example, a plurality of latches 912, 914, 922, and 924 are formed at the side surface cover 910 and the upper surface cover 920. The latches 912, 914, 922, and 924 are formed in the vicinity of corners of the shield can 900. For example, the latch 912 is formed in the vicinity of a first corner of the side surface cover 910, and the latch 914 is formed in the vicinity of another corner of the side surface cover 910 opposite the first corner of the side surface cover 910. Therefore, the latch 912 and the latch 914 are disposed asymmetrically.

Additionally, the latch 922 is formed in the vicinity of a first corner of the upper surface cover 920, and the latch 924 is formed in the vicinity of another corner of the upper surface cover 920 opposite the first corner of the upper surface cover 920. Therefore, the latch 922 and the latch 924 are disposed asymmetrically.

Latching protrusions 170 are disposed on the fixed unit to correspond the plurality of latches 912, 914, 922, and 924. Latching protrusions 172 are disposed to correspond to and engage latches 922 and 924, while latching protrusions 174 are disposed to correspond to and engage latches 912 and 914.

Long holes 916 are formed in the shield can 900. For example, the long holes 916 exposing portions of the substrate 400 are formed in the side surface cover 910. The long holes 916 extend up from a lower end of the side surface cover 910 in the optical axis direction.

The camera module 10 includes the image sensor unit 500. For example, the camera module 10 includes the image sensor unit 500 converting light into electrical signals. The image sensor unit 500 includes an image sensor 510 a printed circuit board 520, a driving element 530, and connection terminals 522 connected, respectively, to the substrate 400 and the sensor member 800.

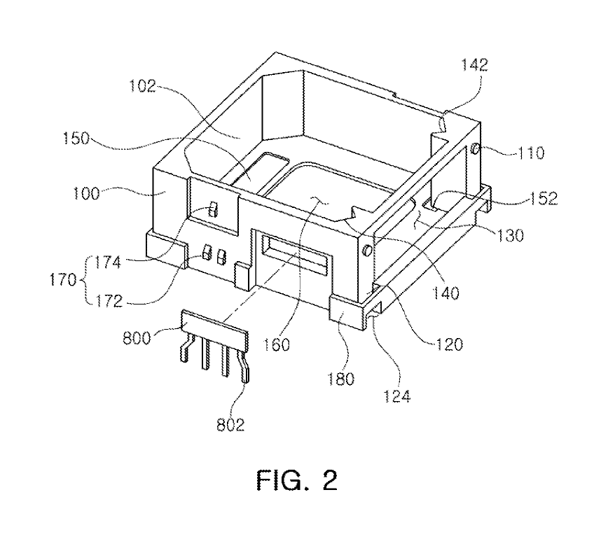

In reference to FIG. 2, the fixed unit 100 firmly couples to the substrate 400. For example, fitting grooves 120 into which portions of the substrate 400 are fitted are formed in the fixed unit 100. Protrusions 110 corresponding to coupling apertures 410 of the substrate 400 are formed on the fixed unit 100.

The fixed unit 100 is configured to easily connect the substrate 400 and an external terminal to each other. For example, exposure openings 124 connected to the fitting grooves 120 are formed in a side surface of the fixed unit 100. The connection pads 600 of the substrate 400 are exposed by the exposure openings 124.

Generally, the substrate of the camera module may have circuits printed on opposing surfaces thereof. However, since the substrate having the form described above has high manufacturing costs and is relatively thick, it may hinder reductions in manufacturing costs, thinning, and miniaturization of the camera module. In addition, an unexpected electrical connections between a coil and the printed circuits may occur in the substrate having the form described above.

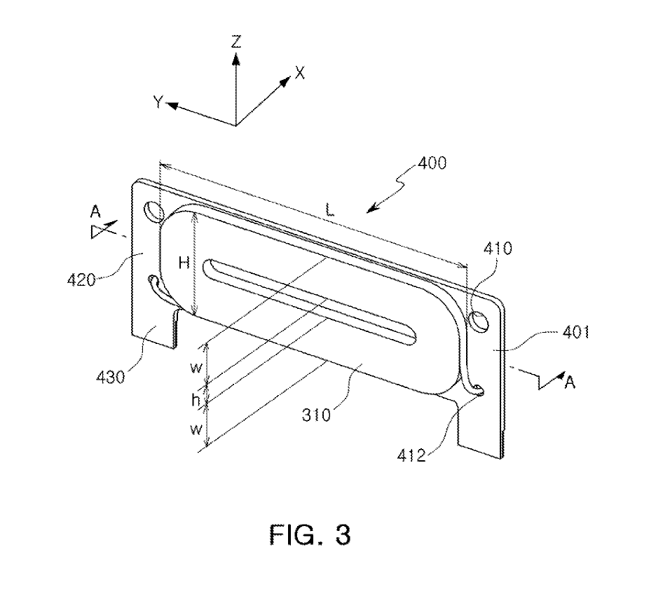

Referring to FIG. 3, a front structure of the substrate 400 which overcomes the above described disadvantages is illustrated. The substrate 400 supports the coil member 310. The coil member 310 is disposed on a first surface 401 of the substrate 400. The first surface 401 of the substrate 400 on which the coil member 310 is disposed does not have a circuit printed thereon. Therefore, the substrate 400 prevents unnecessary electrical connections, or shorts, between the coil member 310 and a printed circuit.

The coupling holes 410 and lead out holes 412 are formed in the substrate 400. The coupling holes 410 are coupled to the protrusions 110 of the fixed unit 100. The lead out holes 412 allow connection portions, or connection terminals, of the coil member 310 to be led out to a second surface 402 of the substrate 400.

The substrate 400 includes two or more parts. The substrate 400 includes a body part 420 and extension parts 430. The body part 420 provides a space on which the coil member 310 is disposed. The extension parts 430 are fitted into the fitting grooves 120 of the fixed unit 100.

The coil member 310 is advantageously thin. For example, a height of the coil member 310 in the optical axis direction is significantly reduced as compared with conventional coil members. A winding width W of the coil member 310 is greater than a height h of a central hole formed by the coil member 310. The height h of the hole may be smaller than ½ of the winding width W. A length L of the coil member 310 (in the direction perpendicular to the optical axis, for example the Y axis direction) may be two or more times greater than a height H of the coil member 310 (in the optical axis direction).

A rear structure of the substrate is illustrated in FIG. 4.

Referring to FIG. 4 the substrate 400 has a single sided substrate form. In other words, a circuit is printed on only the second surface 402 of the substrate 400. The connection pads 600 are also formed on the second surface 402 of the substrate 400. The connection pads 600 formed on the extension parts 430 of the substrate 400 are connected to the connection terminals 522 of the image sensor unit 500. The connection pads 600 are also electrically connected to the coil member 310. The connection pads 600 may be connected to the coil member 310 connection portions led out through the lead out holes 412. The connection pads 600 and the coil member 310 are electrically connected to each other by a method such as soldering.

Testing pads 610 are formed on the second surface 402 of the substrate 400. The testing pads 610 are connected to the connection pads 600, and provide a space that test pins may contact.

A cross-sectional structure of the substrate is illustrated in FIG. 5.

Referring to FIG. 5, the substrate 400 includes a resin layer 404, a metal layer 406, and a protective layer 408. The resin layer 404 comprises a core of the substrate 400. To this end, the resin layer 404 comprises a relatively hard material. The metal layer 406 is formed on a second surface of the resin layer 404, and forms the connection pads 600 and the testing pads 610. The protective layer 408 is formed on the second surface of the resin layer 404, and covers the metal layer 406 so that a significant portion of the metal layer 406 is not externally exposed.

In the substrate 400, configured as described above, the metal layer 406 is formed on one surface of the resin layer 404, in order to reduce a thickness of the substrate 400 as well as the cost of manufacturing the substrate 400. In addition, the coil member 310 is disposed on a surface opposite the metal layer, thereby preventing unnecessary contact between the coil member 310 and the circuit.

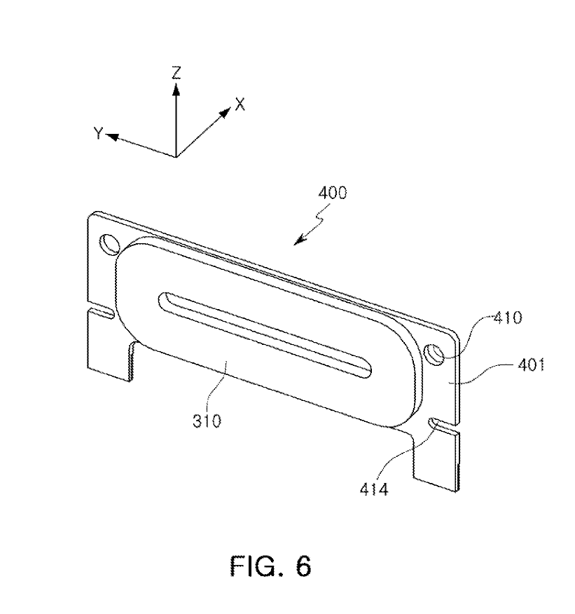

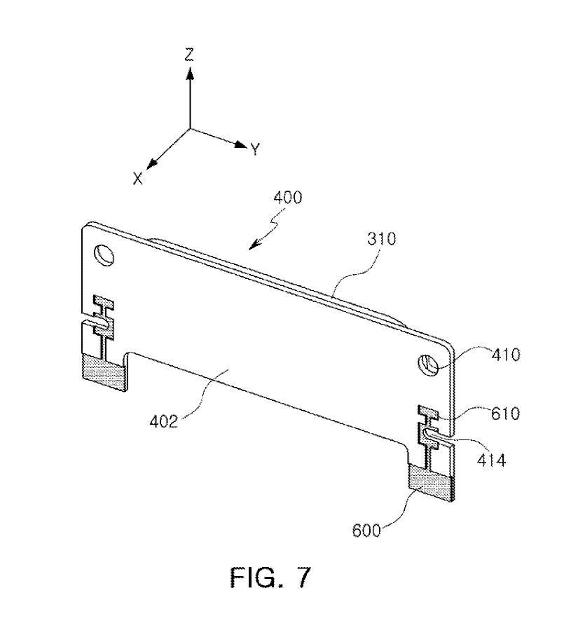

FIGS. 6 and 7 illustrate another embodiment of the substrate. Referring to FIGS. 6 and 7, the substrate 400 includes lead out grooves 414, for withdrawing the coil member 310, are formed in the substrate 400. Connection portions of the coil member 310 extend from the first surface 401 of the substrate 400 to the second surface 402 of the substrate 400 through the lead out grooves 414 which are open to side surfaces of the substrate 400. Thus, the coil member 310 may be easily withdrawn.

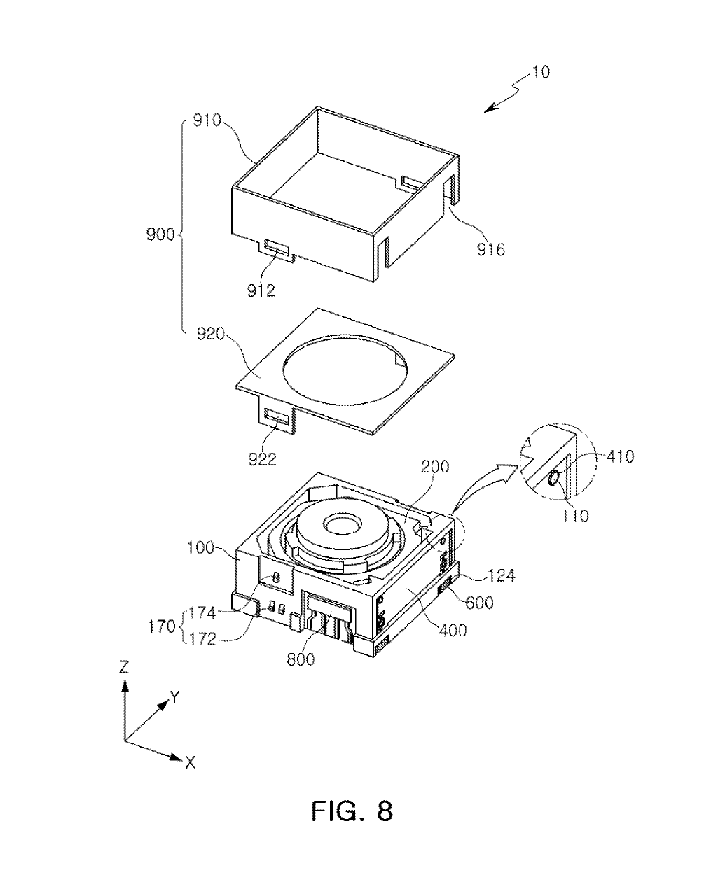

Referring to FIG. 8, the camera module 10may have a reduced thickness. For example, the camera module 10 is configured so that the movable unit 200 is disposed within in the fixed unit 100. The shield can 900 prevents the movable unit 200 from separating from the fixed unit. The substrate 400 is disposed on a side surface of the fixed unit 100.

The substrate 400 is coupled to the protrusions 110 of the fixed unit 100. The protrusions 110 of the fixed unit 100 are coupled to the holes 410 of the substrate 400 to prevent the substrate 400 from separating from the fixed unit 100 and to align the substrate 400 with the fixed unit 100.

The substrate 400 disposed on the fixed unit 100 so that the coil member 310 faces the movable unit 200. The connection pads 600 of the substrate 400 are exposed externally through the exposure openings 124 when mounted on the fixed unit 100.

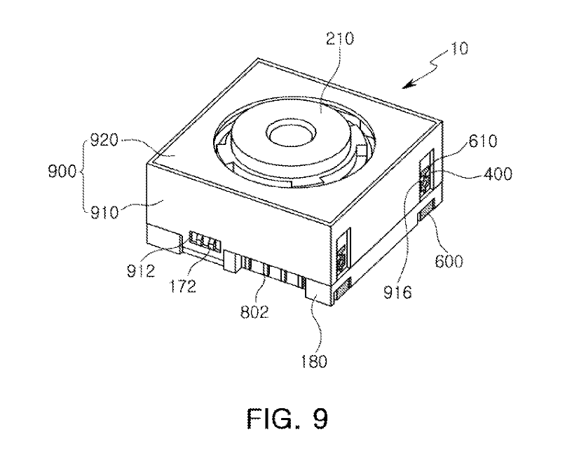

Referring to FIG. 9, the camera module 10 is configured so that the substrate 400 is easily connected to the printed circuit board 520 of the sensor unit 500. For example, the connection pads 600 of the substrate 400 and the connection terminals 522 of the printed circuit board 520 easily contact each other by coupling the fixed unit 100 and the image sensor unit 500 to each other. The connection pads 600 of the substrate 400 are aligned with the connection terminals 522 of the printed circuit board 520 and both elements are exposed to a side surface of the camera module 10. Therefore, the connection pads 600 of the substrate 400 and the connection terminals 524 of the printed circuit board 522 are easily connected to each other by soldering.

The camera module 10 is configured so that the sensor member 800 and the printed circuit board 520 are easily connected to each other. For example, the terminals 802 of the sensor member 800 and the connection terminals 522 of the printed circuit board 520 easily contact each other by coupling the fixed unit 100 and the image sensor unit 500 to each other. The terminals 802 of the sensor member 800 is aligned with the connection terminals 522 of the printed circuit board 520 and both elements are exposed to a side surface of the camera module 10. Therefore, the terminals 802 of the sensor member 800 and the connection terminals 522 of the printed circuit board 520 are easily connected to each other by soldering.

The camera module 10 is further configured so that the connection pads 600 and the terminals 802 are outside of the shield can 900. For example, the shield can 900 extends to the step portions 180 of the fixed unit 100. Therefore, the shield can 900 does not cover the connection pads 600 and the terminals 802.

The camera module 10 is further configured so that a quality test thereof can be easily performed. Generally, the quality test of the camera module 10 is performed by connecting test pins to the connection pads 600. However, when solder are formed on the connection pads 600, it may be difficult to obtain reliability of a contact between solder having a hemispherical shape and the test pins. In the camera module 10, the testing pads 610 connected to the connection pads 600 are formed in order to solve this problem. Therefore, in the camera module 10 according to the one or more embodiments, reliability of electrical connection between the connection pads 600 and test pins is improved due to the testing pads 610.

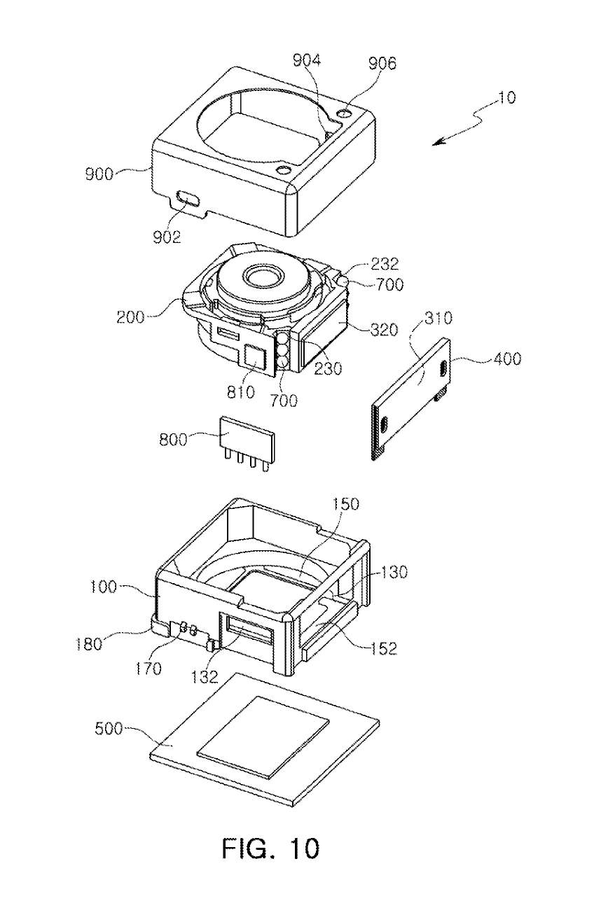

Referring to FIG. 10, a camera module 10 according to another embodiment, the shield can 900 has an integrated side surface cover and upper surface cover. The shield can 900 as described above may be easily manufactured and assembled.

The shield can 900 includes a coupling component for coupling to the fixed unit 100. For example, the shield can 900 includes a latch 902 coupled to the latching protrusion 170 of the fixed unit 100. The shield can 900 includes a component for preventing separation of the rolling members 700. A plurality of pressing protrusions 906 extended downwardly (in FIG. 10) in the optical axis direction are formed on an upper surface of the shield can 900.

The pressing protrusions 906 are disposed to face the rolling members 700 disposed in the respective accommodating grooves 230 and 232. The pressing protrusions 906 extend downward, in the optical axis direction, within the accommodating grooves 230 and 232 to thereby contact the rolling members 700. The pressing protrusions 906 disposed as described above effectively prevent the rolling members 700 from separating from the accommodating groove 230 and 232. The pressing protrusions 906 may be formed through press working. For example, the pressing protrusion 906 may be formed integrally with the shield can 900 at the time of manufacturing the shield can 900 through press forming.

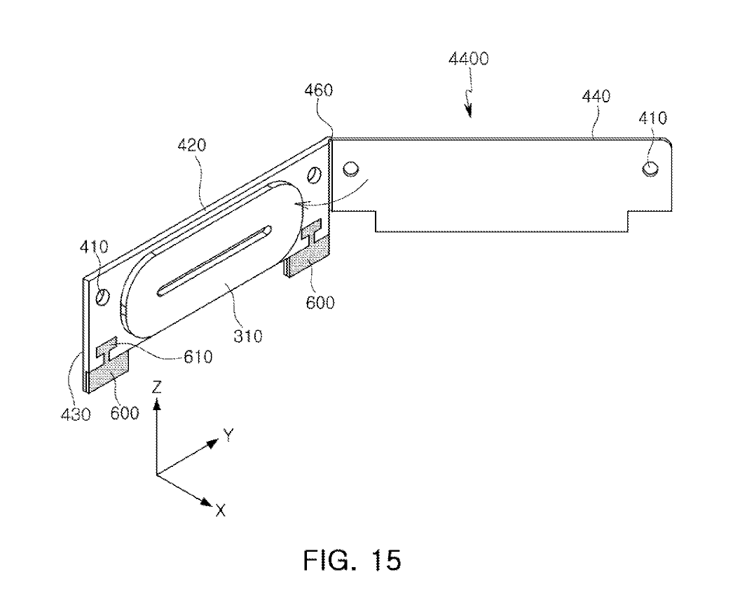

According to another embodiment, the substrate 400 is folded in the vertical direction (See FIG. 15). The substrate 400 is configured so that the coil member 310 and the connection pads 600 are disposed on the same surface. A structure of the substrate 400 will be described in detail below.

The fixed unit 100 is configured so that the sensor member 800 is easily mounted. For example, a fitting opening 132 for mounting the sensor member 800 is formed in a side surface of the fixed unit 100.

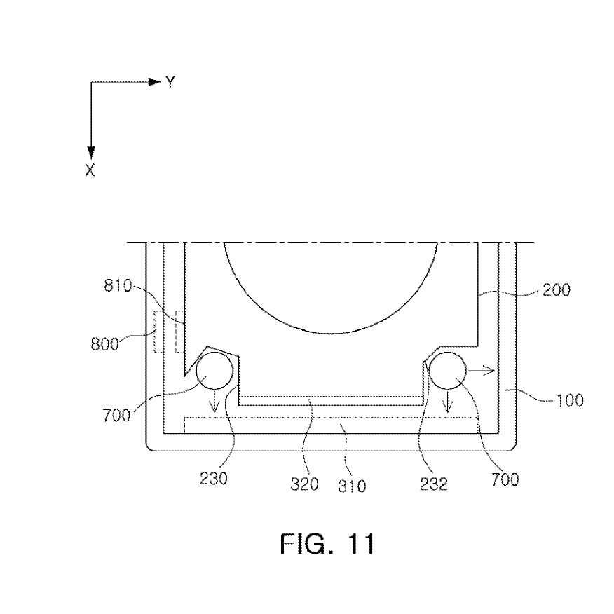

A coupling structure between the movable unit 200 and the rolling members 700 will be described with reference to FIG. 11.

Referring to FIG. 11, the movable unit 200 is movable, relative to the fixed unit 100. The movable unit 200 moves in the optical axis direction. The rolling members 700 are configured for the purpose of smooth movement of the movable unit 200. For example, the rolling members 700 are disposed in the accommodating grooves 230 and 232 of the movable unit 200.

The accommodating grooves 230 and 232 ensure a degree of freedom of the rolling members 700. For example, the accommodating groove 230 is open in a first direction (X axis direction in FIG. 11), and the accommodating groove 232 is open in first and second directions (X and Y axis directions in FIG. 11). The accommodating grooves 230 and 232 enable alignment of a position of the movable unit 200 in the first and second directions. For example, a position of the movable unit 200 in the X axis direction may be adjusted by the coil member 310 and the magnet member 320. A position of the movable unit 200 in the Y axis direction is determined by the sensor member 800 and the magnetic body 810. Therefore, in the camera module 10, the position of the movable unit 200 with respect to the fixed unit 100 are very easily adjusted, and an optical axis of the movable unit 200 and an optical axis of the image sensor unit 500 may be aligned with each other.

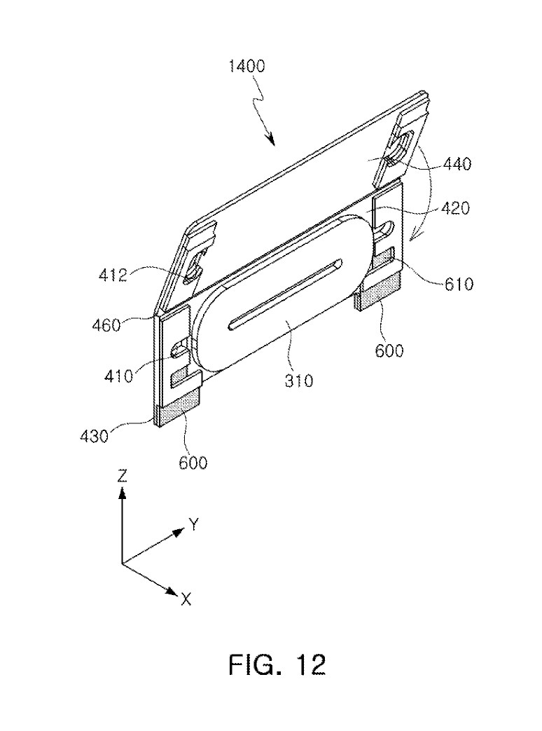

Referring to FIG. 12, the substrate 1400, according to another embodiment, is folded along the horizontal direction (in the Y-axis direction). The substrate 1400 includes a body part 420 and a cover part 440. The body part 420 and the cover part 440 are disposed along the optical axis direction (Z axis direction in FIG. 12). The body part 420 occupies a significant portion of the substrate 1400. For example, the coil member 310 and the connection pads 600 are disposed on the body part 420. A metal layer for connecting the coil member 310 and the connection pads 600 to each other is formed on the body part 420. The cover part 440 enables electrical insulation of the coil member 310. For example, the cover part 440 includes only a resin layer or a resin layer and a protective layer. The cover part 440 covers at least a portion of the body part 420. The cover part 440 is folded over the body part 420 in relation to a separation groove 460 extending in the Y-axis direction. The cover part 440 configured as described above prevents a contact between the coil member 310 disposed on the body part 420 and other electrical and electronic components.

The substrate 1400 includes extension parts 430. A pair of extension parts 430 extend in one direction are formed at the body part 420. The connection pads 600 are disposed on the extension parts 430. The extension part 430 extend passed the lower edge of the substrate 1400 so as not to be covered by the cover part 440. Therefore, the connection pads 600 formed on the extension parts 430 are externally exposed even when the body part 420 is covered by the cover part 440.

The separation groove 460 is formed in the substrate 1400 along a Y-axis direction. The separation groove 460 visibly separates the body part 420 and the cover part 440 from each other. The separation groove 460 enables the substrate 1400 to be folded. The separation groove 460 is the thinnest portion of the substrate 1400. Additionally, the separation groove 460 may be formed from a ductile material. For example, a metal such as copper, may be formed in the separation groove 460 to allow a folded state of the substrate 1400 to be stably maintained.

The substrate 1400 has holes formed therein. For example, holes 410 and 412 into which the protrusions 110 of the fixed unit 100 are fitted are formed in the body part 420 and the cover part 440. The holes 412 of the cover part 440 have a significant size. For example, the holes 412 of the cover part 440 are sized to visibly expose the testing pads 610 of the body part 420.

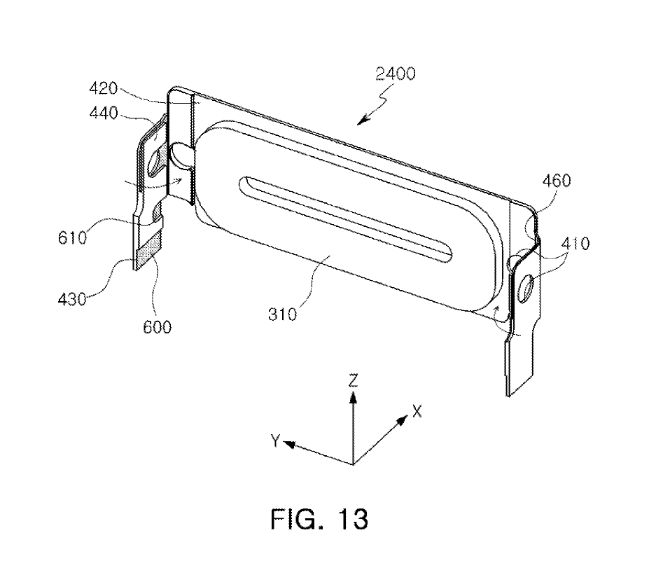

Referring to FIG. 13, a substrate 2400 according to another embodiment includes cover parts 440 disposed on both sides of the body part 420. The cover parts 440 are disposed on the lateral sides of the body part 420.

The cover parts 440 are folded, along the z-axis, over the body part 420. The extension parts 430 are formed on the cover parts 440. The cover parts 440 extend further downward as compared with the body part 420. The connection pads 600 and the testing pads 610 are formed on the extension parts 430. Therefore, even though the cover parts 440 are folded on the body part 420, the connection pads 600 and the testing pads 610 of the extension part 430 are exposed externally of the body part 420.

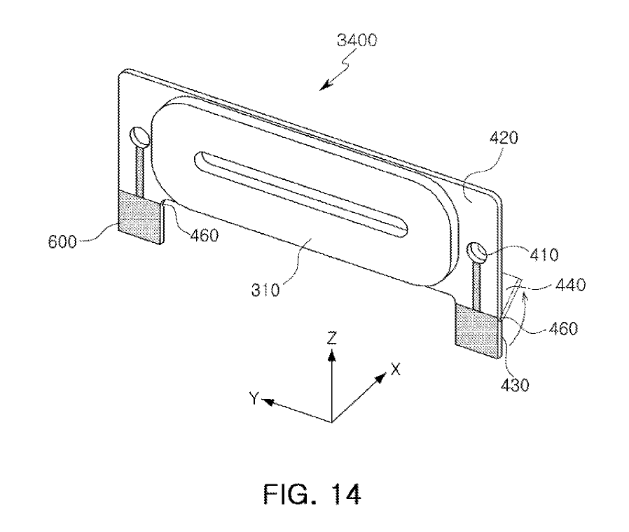

Next, a substrate according to another embodiment is illustrated in FIG. 14.

Referring to FIG. 14, the cover part 440 is disposed below the body part 420. For example, the cover part 440 has extension parts 430 extending downward, below the body part 420. The cover part 440 is folded toward the rear of the body part 420. Therefore, the coil member 310 is disposed on one surface of the substrate 3400 and the connection pads 600 are disposed on the other surface of the substrate 3400.

A substrate 4400 according to another embodiment is illustrated in FIG. 15.

Referring to FIG. 15, the body party 420 is connected to the cover part 440 are along a lateral side. A separation groove 460 extends in the z-axis direction and is disposed between the cover part 440 and the body part 420. Extension parts 430 of the substrate 4400 extend down from the bottom of the body part 420. The connection pads 600 are formed on the extension parts 430. The testing pads 610 are disposed on the body part 420 above the extension parts. The cover part 440 covers a significant portion of the body part 420. For example, the cover part 440 completely covers the coil member 310 of the body part 420, and portions of the cover part 440 have cutout to expose the extension parts 430 to the outside.

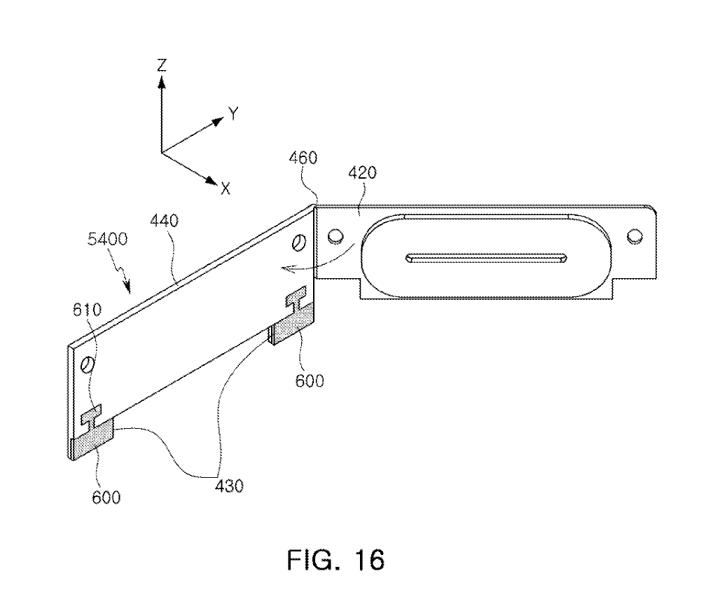

Next, a substrate 5400 according to another embodiment is illustrated in FIG. 16. Referring to FIG. 16, the substrate is similar to the substrate 5400 of FIG. 15, except the extension parts 430 extend from the bottom of the cover part 440 instead of the body part 420. Therefore, the coil member 310 is disposed on the body part 420, and the connection pads 600 are disposed on the cover part 440. In this configuration, a sufficient space for the coil member 310 and the connection pads 600 is provided.

As set forth above, according to exemplary embodiments in the present disclosure, the actuator may be easily mounted and connected.

As a non-exhaustive example only, a device as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a fixed unit comprising an accommodating space;
a moveable unit disposed in the accommodating space;
an actuator configured to drive the movable unit in an optical axis direction;
a substrate, disposed on a first side surface of the fixed unit, comprising a coil member of the actuator disposed on a first surface of the substrate; and
connection pads, disposed on a second surface of the substrate, electrically connected to the coil member.

2. The camera module of claim 1, wherein a winding width of the coil member is greater than a height of a central hole enclosed by the coil member, wherein in the height extends in the optical axis direction.

3. The camera module of claim 1, wherein lead out holes through which connection portions of the coil member are led out to the second surface of the substrate are formed in the substrate.

4. The camera module of claim 1, wherein the fixed unit further comprises protrusions, and the substrate further comprises coupling holes configured to receive the protrusions.

5. The camera module of claim 1, wherein the substrate further comprises testing pads electrically connected to the connection pads.

6. The camera module of claim 1, wherein extension parts extend from an end of the substrate.

7. The camera module of claim 1, further comprising rolling members disposed between the fixed unit and the movable unit.

8. The camera module of claim 1, wherein the fixed unit further comprises fitting grooves configured to accommodate portions of the substrate.

9. The camera module of claim 1, wherein the fixed unit further comprises a coupling opening disposed in one side surface of the fixed unit.

10. The camera module of claim 1, wherein the fixed unit further comprises first and second accommodating grooves, and
rolling members are disposed in the first and second accommodating grooves.

11. A camera module comprising:
a fixed unit comprising a space;
a moveable unit disposed in the space;
an actuator configured to drive movable unit in an optical axis direction; and
a substrate disposed on the fixed unit,
wherein the substrate comprises:
a coil member disposed on a body part;
a cover part folded over at least a portion of the body part; and
connection pads connected to the coil member.

12. The camera module of claim 11, wherein the substrate further comprises extension parts extending in one direction.

13. The camera module of claim 11, wherein the body part and the cover parts are aligned in the optical axis direction.

14. The camera module of claim 11, wherein the body part and the cover parts are aligned in a direction perpendicular to an optical axis.

15. The camera module of claim 11, wherein the cover parts are disposed on both sides of the body part.

16. The camera module of claim 11, wherein a separation groove extending in the optical axis direction is disposed between the body part and the cover part.

17. The camera module of claim 11, wherein a separation groove extending in a direction perpendicular to the optical axis direction is disposed between the body part and the cover part.

18. A camera module comprising:
a fixed unit comprising a space;
a moveable unit disposed in the space;
an actuator configured to drive movable unit in an optical axis direction; and
a substrate disposed on the fixed unit,
wherein the substrate comprises:
a coil member disposed on a body part;
a cover part folded over at least a portion of the body part; and
connection pads extending from the cover part, wherein the connection pads are electrically connected to the coil member.

19. The camera module of claim 18, wherein a separation groove extending in the optical axis direction is disposed between the body part and the cover part.
